(19) United States
(12) Patent Application Publication
(10) Pub. No.: US 2002/0152797 A1
(43) Pub. Date: Oct. 24, 2002

(54) Gas delivery apparatus and method for monitoring a gas phase species therein

(76) Inventors: James J.F. McAndrew, Lockport, IL (US); Eric L. Duchateau, Gieres (FR); Jean-Marc Girard, Tsukuba-shi (JP); Alan D. Zdunek, Chicago, IL (US)

Correspondence Address: E. Joseph Gess, BURNS, DOANE, SWECKER & MATHIS, L.L.P., P.O. Box 1404, Alexandria, VA, 22313-1404, US

(21) Appl. No.: 10/035,179

(22) Filed: Jan. 4, 2002

Related U.S. Application Data
(60) Provisional application No. 60/260,218, filed on Jan. 9, 2001.

(51) Int. Cl. G01N 29/02

(52) U.S. Cl. 73/23.2

(57) ABSTRACT

Provided are novel gas delivery apparatuses. In accordance with one aspect of the invention, the apparatus features: a gas line network for delivering a gas from a gas source to a point of use; means for performing one or more vacuum/purge cycle in the gas line network, the vacuum/purge cycle including a vacuum phase and a purge phase; and a measurement system for detecting a gas phase molecular species in the gas line network during the vacuum phase and/or the purge phase of the vacuum/purge cycle. Also provided are methods for monitoring a gas phase molecular species in a gas delivery apparatus. The invention allows for replacement of components in a gas delivery system in a manner which is safe, and which avoids detrimental impact on the process being run and on the equipment.

### CROSS REFERENCE TO RELATED APPLICATIONS

This application claims the benefit under 35 U.S.C. §119(e) of Provisional Application No. 60/260,218, filed Jan. 9, 2001, the entire contents of which application are incorporated herein by reference.

### BACKGROUND OF THE INVENTION

1. Field of the Invention

The present invention relates to novel gas delivery apparatuses, and to novel methods for monitoring a gas phase molecular species in a gas delivery apparatus. The apparatuses and methods allow, for example, for replacement of components in a gas delivery system in a manner which is safe, and which avoids detrimental impact on the process being run and on the equipment. The invention has particular applicability to the manufacture of electronic devices, for example in semiconductor device fabrication.

2. Description of the Related Art

In the semiconductor manufacturing industry, integrated circuits (ICs) are manufactured by a series of processes, many of which involve introducing one or more gas phase material to the process tool. Such processes include, for example, etching, diffusion, oxidation, rapid thermal processing, chemical vapor deposition (CVD), ion implantation and sputtering processes.

The materials are typically stored in gas cylinders or bulk storage vessels in a gas or liquid state, depending on the material, and are withdrawn from such containers directly in the gas phase. Other materials such as organometallic materials may be in a liquid state at standard temperature and pressure. Such materials typically require the use of a vaporizer or bubbler to be brought into the gas phase for delivery to the process tool.

In delivering these materials to a point-of-use, the source is connected to one or more points-of-use, for example, semiconductor process tools, by a gas line network which includes components such as valves, regulators, filters, mass flow controllers and other flow control devices, in addition to the gas piping. FIG. 1 illustrates a conventional system 100 for delivering a gas to a semiconductor processing tool. Gas cylinders housed in gas cylinder cabinets 102, 104 are connected by gas line networks to one or more semiconductor processing tools 106, 108, 110, 112.

As part of the gas line network, the gas cylinder cabinets typically include gas purge panels which are employed during connection and disconnection of process gas cylinders contained in gas cabinets to and from the gas line network. To allow a single gas cabinet to service a plurality of process tools, a vacuum manifold box (VMB) 114 can be employed. The VMB is typically located inside or a short distance away from the gas cabinet and includes, for example, gas lines together with valves, pressure sensors and other flow control devices, and divides the gas flow from one or more gas inlet lines into a greater number of gas lines which exit the VMB. One or more gas is typically introduced into the process tool 106 through a gas panel 116 at the process tool. The gas panel includes similar components as the VMB, and mass flow controllers for accurately introducing the process gases into the process tool.

Contamination in the form of moisture in the gas line network can be particularly problematic. Water vapor can adversely impact semiconductor processing performance and additionally lead to particle formation through reaction with process gases and corrosive interaction with components of the gas delivery system. Poor film properties, uniformity and particle counts can result in a lowering in yield of the devices being formed.

While particles tend to be the most significant contaminants in the processing chambers of the semiconductor processing tools, they are relatively easily removed from the gas delivery system by filtration. Molecular contaminants such as water vapor, on the other hand, are more difficult to remove. This is a result of their strong interaction with the gas delivery system.

The gas line network is potentially exposed to atmospheric moisture each time a connection is broken in the line. This occurs, for example, during periodic maintenance such as when a gas cylinder, liquid chemical vessel or some other component of the system is replaced. In the case of gas cylinder replacement, for example, in corrosive gas service, this can lead to corrosion of the “pigtail” used to connect the cylinder to the gas panel, as well as other parts of the gas delivery system. Associated with this corrosion is a large expense for replacement of parts in terms of process downtime during the replacement, as well as the cost of the parts.

FIG. 2 illustrates a schematic and simplified diagram of the layout of a known gas delivery system 200 which includes a gas panel 202. The illustrated gas panel is an RPV (reduced purge volume) gas panel, commercially available from Air Liquide. See also U.S. Pat. No. 5,749,389.

Operation of the conventional gas panel will be described briefly. The details regarding specific valve operation are similar to those described below with reference to the inventive apparatuses and methods. The procedure is typically carried out once a gas cylinder is deemed “empty”, i.e., when a residual amount of material remains in the cylinder as measured by cylinder pressure or weight.

Prior to disconnection and removal of the empty gas cylinder 204 from the gas cabinet (enclosure shown as 206), the cylinder valve 208 is first closed. A number of repeated vacuum/purge cycles are then carried out to remove residual process gas from the gas line network leading up to the gas cylinder 204. In so doing, the gas line network is evacuated by a vacuum pump (not shown) or a venturi system, which includes a venturi 210, a venturi nitrogen feed line 212 connected to a nitrogen gas source and a venturi gas outlet line 214. Nitrogen gas is introduced into the venturi 210 through the venturi feed line 212 and is removed through the venturi gas outlet line 214. Once a predetermined vacuum level in the system has been reached, the vacuum phase is complete and the purge phase begins.

Nitrogen purge gas is then introduced into the gas line network through purge gas line 216, and the gas lines up to the gas cylinder 204 are pressurized until a predetermined pressure is attained. The vacuum/purge cycle is repeated a predetermined number of times to ensure that no residual process gas is present in the gas piping so that the gas cylinder 204 can safely be disconnected.

Prior to disconnecting the cylinder 204, a continuous stream of nitrogen is allowed to flow through the fitting 218 which connects the gas cylinder to the gas line network. This flow of purge gas is to prevent the ingress of air into, and resulting contamination of, the gas delivery system when the fitting 218 is exposed to atmosphere.

The empty cylinder is removed from the gas cylinder cabinet 206 and is replaced with a fresh cylinder. After connecting the fresh cylinder to the fitting 218, additional vacuum/purge cycles are performed to remove ambient contamination from the system before the cylinder valve 208 is opened.

The conventional cylinder purge panel has certain disadvantages. For example, the number of vacuum/purge cycles employed is typically determined by experience or by laboratory tests designed to measure the removal of contamination during vacuum/purge cycling. Use of the proper number of vacuum/purge cycles is particularly important in that too small a number of cycles may result in corrosion of the gas system, and possible exposure of the person changing the cylinder to toxic gases. On the other hand, too high a number of cycles results in lost production time.

Moreover, although purging of the fitting 218 during disconnection from the cylinder 204 is generally effective for its intended purpose, moisture invariably is adsorbed on the cylinder valve 208. This moisture, upon connection of the cylinder 204 to the purged fitting 218, is introduced into the gas delivery system when the cylinder valve is opened.

FIG. 3 illustrates a typical vacuum manifold box 114 commercially available from Air Liquide. The process gas enters the VMB from two sources, for redundancy to ensure a continuous supply of gas, through inlets 302 and exits the VMB through outlets 304 to a plurality of process tools 306, 308, 310 and 312. Source isolation valves V1, V2, respectively, are provided for selecting the gas source to be used. The gas passes through a series of valves V3-V7, a regulator 314 and a filter 316 in each of lines 1, 2, 3 and 4 before exiting the VMB.

Purge line 318 connected to a purge gas source is provided to pressurize the VMB lines with a purge gas such as nitrogen during the purge phase of the vacuum/purge cycle. A venturi system including venturi 320, a venturi nitrogen feed line 322 connected to a nitrogen gas source and a venturi gas outlet line 324 are provided for evacuating the VMB during the vacuum phase of the vacuum/purge cycle. Vacuum/purge cycling is performed in the VMB in a manner similar to that described above with respect to the gas panel.

FIG. 4 illustrates a conventional process tool gas panel 116. The different process gases employed in the process tool are introduced into the gas panel through inlets 402, 404, 406, 408, exit the gas panel through outlets 410, 412, 414, 416 and are directed to the process tool 106. The gases each pass through a separate line which includes, for example, a series of valves V1-V3, a regulator 418, a mass flow controller 420 and a filter 422 before exiting the gas panel. The gas panel further includes a purge line 424. The gas lines are evacuated as needed through the vacuum system of the process tool 106.

Both the VMB and process tool gas panel frequently need to be vacuum/purge cycled for periodic maintenance or component changeout. Similar problems to those described above with reference to the purge panels are present when disconnecting or otherwise replacing components of the gas line network, for example, those in the vacuum manifold box and process tool gas panel.

To meet the requirements of the semiconductor manufacturing industry and to overcome the disadvantages of the related art, it is an object of the present invention to provide novel gas delivery apparatuses which allow replacement of components in a gas delivery system in a manner which is safe, and which avoids detrimental impact on the process being run and on the equipment. Without being limitative, examples of such components are gas cylinders, bulk storage vessels, vaporizers, bubblers, valves, regulators, filters and mass flow controllers.

It is a further object of the invention to provide novel methods for monitoring a gas phase molecular species in a gas delivery apparatus.

Other objects and aspects of the present invention will become apparent to one of ordinary skill in the art on a review of the specification, drawings and claims appended hereto.

### SUMMARY OF THE INVENTION

According to a first aspect of the invention, provided is a novel gas delivery apparatus. The apparatus comprises: a gas line network for delivering a gas from a gas source to a point of use; means for performing one or more vacuum/purge cycle in the gas line network, the vacuum/purge cycle comprising a vacuum phase and a purge phase; and a measurement system for detecting a gas phase molecular species in the gas line network during the vacuum phase and/or the purge phase of the vacuum/purge cycle. The point of use can be, for example, a semiconductor processing tool.

In accordance with a further aspect of the invention, a gas delivery apparatus is provided. The apparatus comprises: a gas line network for delivering a gas from a gas source to a semiconductor processing tool; means for performing one or more vacuum/purge cycle in the gas line network, the vacuum/purge cycle comprising a vacuum phase and a purge phase; and an absorption spectroscopy measurement system for detecting a gas phase molecular species in the gas in a sample region during the vacuum phase and/or the purge phase of the vacuum/purge cycle, the measurement system comprising: a light source for directing a light beam into the sample region through a first light transmissive window; and a detector which responds to the light beam which exits the sample region through the first light transmissive window or a second light transmissive window.

In accordance with a further aspect of the invention, provided is a novel method for monitoring a gas phase molecular species in a gas delivery apparatus comprising a gas line network for delivering a gas from a gas source to a point of use. The method comprises: (a) performing one or more vacuum/purge cycle in the gas line network, the vacuum/purge cycle comprising a vacuum phase and a purge phase; and (b) detecting with a measurement system a gas phase molecular species in the gas line network during the vacuum phase and/or the purge phase of the vacuum/purge cycle.

A further aspect of the invention provides a method for monitoring a gas phase molecular species in a gas delivery apparatus comprising a gas line network for delivering a gas from a gas source to a semiconductor processing tool. The method comprises: (a) performing one or more vacuum/purge cycle in the gas line network prior to disconnection from the gas line network of a component in the gas line network, the vacuum/purge cycle comprising a vacuum phase and a purge phase; (b) detecting with a measurement system a gas phase molecular species in the gas line network during the vacuum phase and/or purge phase of step (a); (c) performing one or more vacuum/purge cycle in the gas line network after disconnection and reconnection of the component or connection of a new component, the vacuum/purge cycle comprising a vacuum phase and a purge phase; and (d) detecting with the measurement system a gas phase molecular species in the gas line network during the vacuum phase and/or purge phase of step (c).

### BRIEF DESCRIPTION OF THE DRAWINGS

The objects and advantages of the invention will become apparent from the following detailed description of the preferred embodiments thereof in connection with the accompanying drawings, in which like numerals designate like elements, and in which:

FIG. 1 illustrates a conventional system for delivering a gas to a semiconductor processing tool;

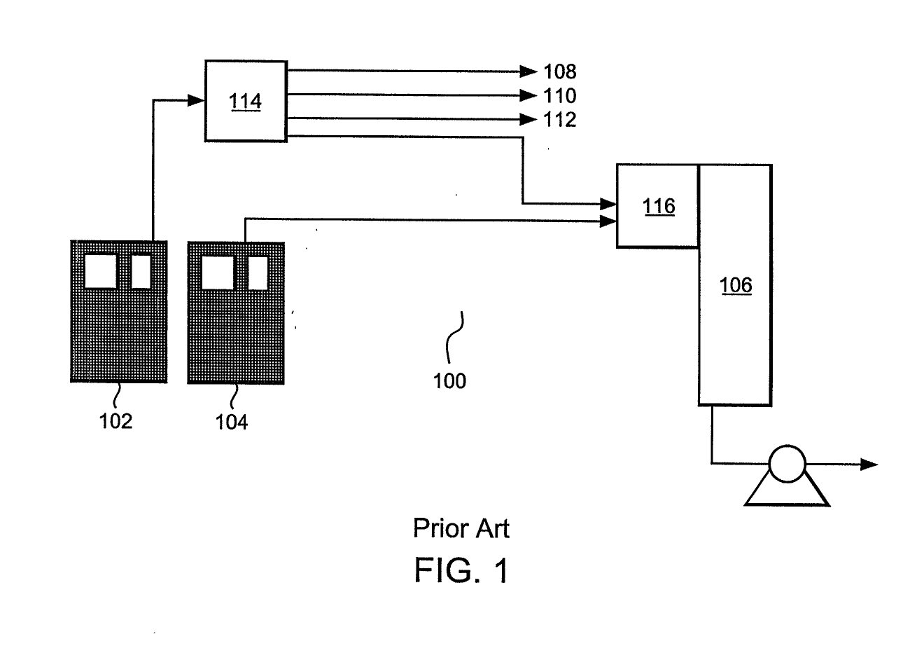

FIG. 2 is a schematic diagram of a conventional gas delivery apparatus which includes a gas purge panel;

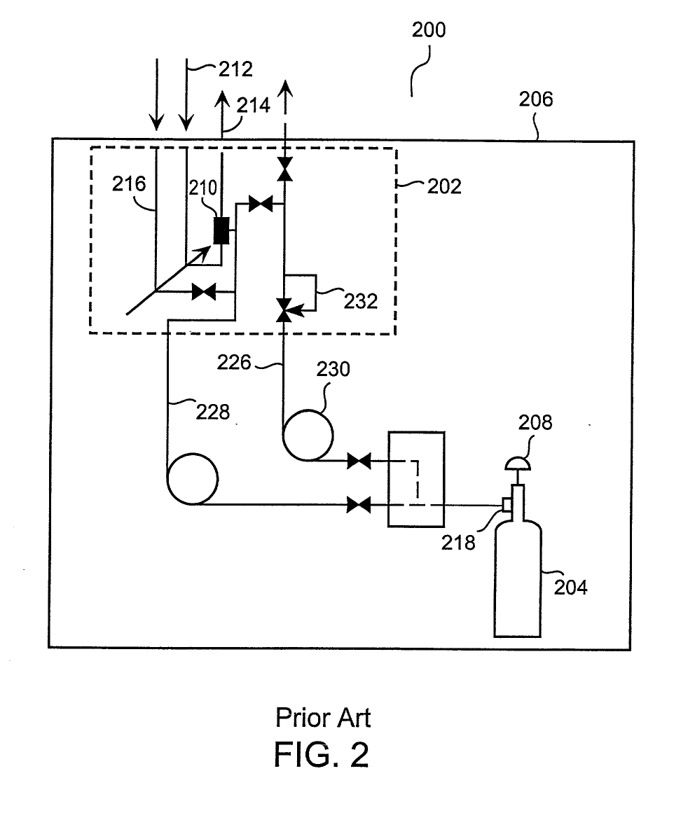

FIG. 3 is a schematic diagram of a conventional vacuum manifold box (VMB);

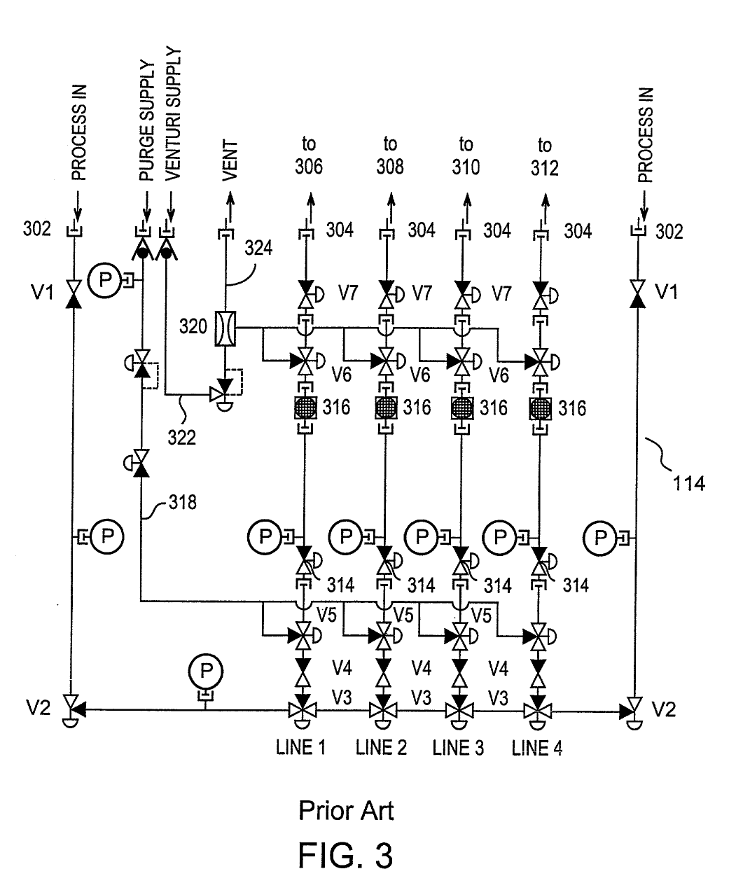

FIG. 4 is a schematic diagram of a conventional process tool gas panel;

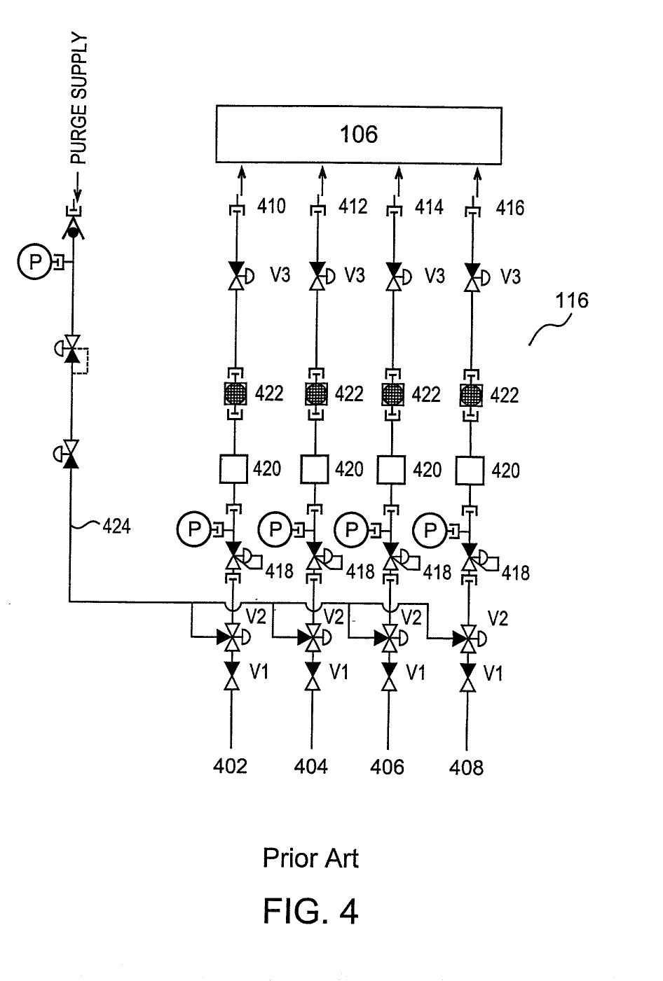

FIG. 5 is a schematic diagram of an exemplary gas delivery apparatus in accordance with the invention which includes a gas purge panel;

FIGS. 6A and 6B are plan views of exemplary measurement systems which can be used in the gas delivery apparatus of the invention;

FIG. 7 is a schematic diagram of an exemplary gas delivery apparatus in accordance with the invention which includes a vacuum manifold box (VMB); and

FIG. 8 is a schematic diagram of an exemplary gas delivery apparatus in accordance with the invention which includes a process tool gas panel.

### DETAILED DESCRIPTION OF PREFERRED EMBODIMENTS OF THE INVENTION

The invention will now be described with reference to various drawing figures, which illustrate exemplary aspects of the invention in terms of their use in a semiconductor manufacturing facility. It should be clear that the invention is applicable to other industries making use of gases and liquid chemicals, such as heat treating, flat panel display manufacturing and thin film coating (e.g., sunglass manufacturing) industries. In addition, while specific gas line distribution configurations are illustrated in the illustrated embodiments, it should be clear that such configurations are in no way limiting but are merely exemplary.

As used herein, the term “gas source” includes but is not limited to materials which are stored in gas cylinders, bulk storage vessels or other vessels in a gas or liquid state, and which are withdrawn from such containers directly in the gas phase, and materials such as organometallics which may be in a non-gaseous state at standard temperature and pressure, and which typically require the use of a vaporizer or bubbler to be brought into the gas phase for delivery to the point-of-use.

The invention is particularly applicable to the delivery of electronic specialty gases (ESG's), useful in the manufacture of semiconductors. Examples of such gases include, but are not limited to, chlorine (Cl₂), boron trichloride (BCl₃), hydrogen chloride (HCl), boron trifluoride (BF₃) and hydrogen bromide (HBr), silanes such as silane (SiH₄), dichlorosilane (SiH₂Cl₂) and trichlorosilane (SiHCl₃), arsine (AsH₃), phosphine (PH₃), diborane (B₂H₆), nitrous oxide (N₂O), ammonia (NH₃), and tungsten hexafluoride (WF₆), as well as to organometallic compounds such as copper hexafluoroacetylacetanato trimethylvinylsilane (Cu(hfac)tmvs) and other copper-containing compounds, and Zr, Hf, Ba, Sr, Ti and Ta-containing organo-compounds.

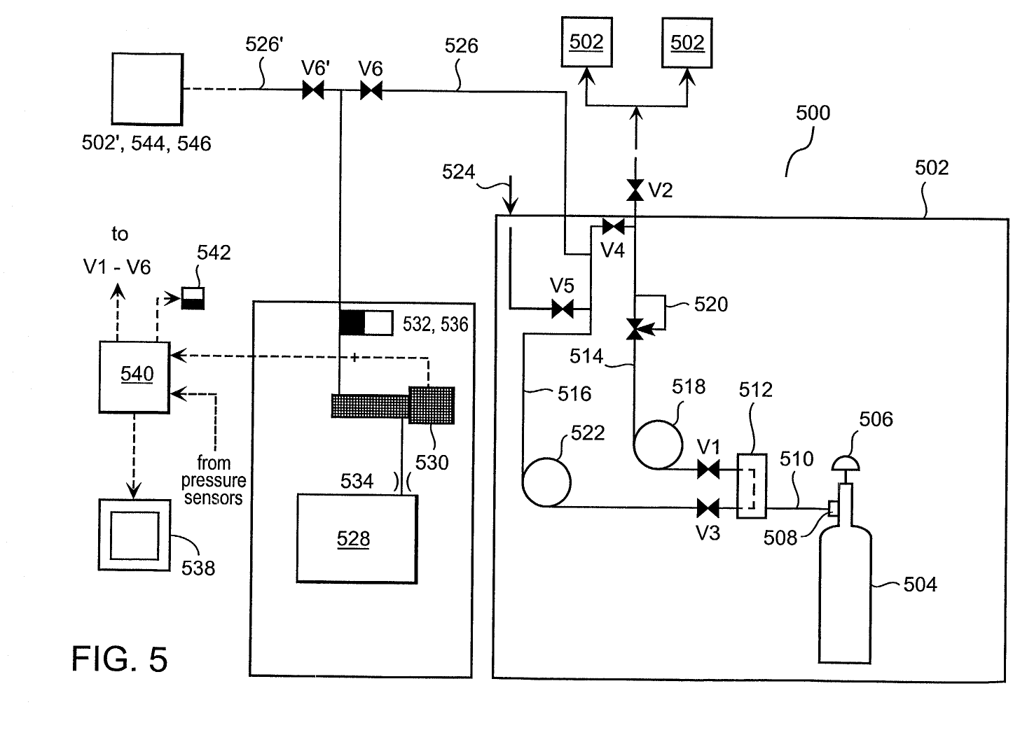

FIG. 5 is a schematic diagram of a gas delivery apparatus 500 in accordance with an exemplary aspect of the invention. The apparatus includes a gas cylinder cabinet 502, commercially available, for example, from Air Liquide, for housing a gas cylinder 504. The cabinet 502 typically houses one or two cylinders, but can house more than two cylinders.

The gas cylinder 504 is connected inside the cabinet 502 to a gas piping network which leads to one or more point of use 502. The gas piping network can take various forms, and that illustrated in FIG. 5 is a preferred, exemplary configuration. In the case of semiconductor manufacturing, the point of use can be one or more semiconductor processing tool, for example, a chemical vapor deposition (CVD), etching, oxidation, diffusion, sputtering, rapid thermal processing and ion implantation systems.

The gas cylinder 504, which has a cylinder valve 506, is connected to the gas delivery system by a connection 508. Connection 508 is connected via a short line 510 to a block 512 into which valves V1 and V3 can be integrated and which is connected to process gas line 514 and a vacuum/purge line 516. The process gas line 514 includes a process gas pigtail 518, a pressure regulator 520 and valves V1 and V2. The process gas line is connected to the one or more point of use 502 which, in this exemplary embodiment, is a semiconductor processing tool. Other configurations, not necessarily including integrated block valves, are possible and well known in the art.

One end of the vacuum/purge line 516 is connected to the process gas line 514 at a point upstream of the pressure regulator 520, and downstream of valve V2. The vacuum/purge line 516 includes valves V3 and V4 at or near each end thereof, and a vacuum/purge pigtail 522.

A nitrogen purge gas line 524 is connected to the gas vacuum/purge line 516 between the vacuum/purge pigtail 522 and valve V4. The nitrogen purge gas line 524 is connected to receive nitrogen from a nitrogen gas source. The nitrogen gas source is preferably of ultra-high-purity, and is preferably in a gas cylinder. While a bulk gas system can be used to supply the nitrogen, the cylinder is preferable due to the possibility of contamination of the main nitrogen line if a bulk source is used. A valve V5 is provided in the purge gas line.

During the purge phase and when the cylinder is being disconnected, valves V5 and V3 are in the opened position, and valves V1 and V4 in the closed position. This allows line 510 to be purged without requiring the purging of line 514. These valves are in the same positions during the vacuum phase except for valve V5 which is closed.

The gas line network is evacuated during the vacuum phase of the vacuum/purge cycle through a vacuum line 526 which is connected to the vacuum/purge line 516, between valve V4 and the vacuum/purge pigtail 522. The opposite end is connected, directly or indirectly, to a vacuum device 528. A valve V6 is provided in the vacuum line 526, which can be opened to allow evacuation of the gas lines during the vacuum phase and, optionally, during the purge phase as well. The vacuum device 528 should be capable of pulling a vacuum preferably of less than about 100 Torr in line 510 during the vacuum phase to ensure substantial removal of the gas contained in the gas line network. The vacuum device preferably includes one or more vacuum pumps selected from, for example, rotary pumps, diaphragm pumps, Roots pumps and turbomolecular pumps. Secondary pumps can be employed to increase the pumping speed. Other types of vacuum devices can be employed, for example, a venturi, assuming the requisite vacuum level can be achieved.

A measurement system 530 is provided in the vacuum line 526, upstream and in series with the vacuum device 528, for monitoring a molecular species of interest in the gas passing through the vacuum line. The vacuum device thus serves the dual purpose of evacuating the gas line network and of pulling the sample gas to be measured through the measurement system 530 during the vacuum phase and, optionally, during the purge phase of the vacuum/purge cycles. Although the measurement system 530 is under vacuum, the purged region 510 is separated from it by a significant length of narrow bore tubing, and can thus be at the much higher pressure necessary for effective purging. If necessary, a pressure controller or needle valve can be introduced into the line 526 in order to have finer control of the pressure in the sensor versus the purge panel. The measured value from the measurement system 530 should be indicative of the concentration of the molecular species of interest during the vacuum phase.

Gas pressure and flow in the measurement system 530 can be controlled by means of a pressure controller 532 located immediately upstream of the measurement system and a suitably-sized orifice 534 downstream. Such a system is described in copending application Ser. No. 09/898,085, filed on Jul. 5, 2001, the entire contents of which are incorporated herein by reference. Another suitable design is to control the gas flowrate through the measurement system 530 by means of a mass flow controller 536 located upstream of the measurement system 530. In this case, the pressure in the measurement system is allowed to vary and the measurement system should be calibrated so as to provide valid measurements independent of pressure, over the expected pressure range, which is typically 5-1000 mbar.

Preferably, the measurement system is capable of monitoring more than one molecular species although this will depend on the particular measurement technique employed. During the vacuum/purge cycles occurring prior to disconnection of the empty cylinder from the gas delivery system, it is desirable to monitor the molecular species of the gas contained in the cylinder. In this way, complete removal of the gas from the system can be ensured before the cylinder is disconnected. This is particularly beneficial for toxic, corrosive and pyrophoric gases, where leakage can raise safety and/or equipment damage issues. The measurement of water vapor is desirable, in particular, for the vacuum/purge cycles occurring after connection of a new cylinder to the gas delivery system. This will help to ensure that water vapor is substantially removed from the gas delivery system prior to opening the cylinder valve 8 and commencing processing with the gas. This helps to prevent the deleterious effects on the process and apparatus components resulting from the presence of water vapor.

The measurement system can preferably be used to monitor different molecular species in the gas delivery system. Certain types of detectors, however, do not lend themselves to monitoring more than a single molecular species of interest. In such case, one or more additional detectors can be employed to monitor the additional species. In such case, additional gas piping, fittings, valves, etc., can be employed to divert the sample gas flow between different detectors, using the same or a different vacuum device 528.

Exemplary types of measurement systems which can be used in the gas delivery apparatus include, for example, absorption spectroscopy measurement systems, for example, tunable diode laser absorption spectroscopy (TDLAS), Fourier transform infrared spectroscopy (FTIR), mass spectroscopy (MS), ultraviolet-visible spectroscopy (UV-VIS) and non-dispersive infrared spectroscopy (NDIR). TDLAS has been found to be particularly preferred as the measurement technique and is further described below. Implementation of other types of measurement systems can be accomplished by persons skilled in the art based on the teachings herein.

1. Principles of Operation of TDLAS Measurement System

When light is absorbed by molecules in the path of light of frequency ν, the measured absorbence can be converted into the partial pressure of the species of interest according to Beer's Law, according to the following equation:

$$T ( ν ) = \frac{I ( ν )}{{I}_{0} ( ν )} = exp ( - α ( ν ) c1 )$$

or, in the case of small absorptions, according to the following equation:

$$\frac{{I}_{0} ( ν ) - I ( ν )}{{I}_{0} ( ν )} \approx α ( ν ) c1$$

In the above equations, T(ν) is the transmittance at frequency ν, I(ν) is the light intensity measured at the detector after passing through the sample cell, I₀(ν) is the light intensity in the absence of absorption, α(ν) is the absorption coefficient at frequency ν, c is the concentration of the absorbing species and l is the pathlength. The absorption coefficient α is typically stated in terms of a lineshape function (ν) and an intensity factor S, according to the following equation:

α(ν)=SK(ν)

wherein K has the well-known Gaussian, Lorentzian or Voigt form.

To eliminate low frequency noise sources, the sensor preferably uses wavelength modulation spectroscopy with second harmonic detection. The laser output is modulated at a frequency f with a modulation amplitude m, according to the following equation:

ν→ν+mcos(2πft)=ν+mcosθ

The detector signal is demodulated to obtain the component in phase with 2f. The demodulated signal (V₂) is proportional to the 2f term in the Fourier expansion of α(ν), shown as the following equation:

$${V}_{2} = {CI}_{0} Scl {\int }_{- Π}^{Π} K ( ν + m cos θ ) cos ( 2 θ ) ⅆ θ$$

wherein S and K(ν) are available for the water vapor absorption spectrum over the pressure and temperature range usually found in the exhaust conduits of semiconductor process tools. The integral is evaluated numerically assuming a Voigt profile. The proportionality constant C is determined by the response of the detector and signal processing electronics. In principle, C may be evaluated from first principles, but it is more practical to measure V₂/I₀ for known c, l, K(ν) and m, and hence deduce C. It is important to verify that the signal-processing electronics response produces a response that varies linearly with water vapor concentration and to repeat the calibration periodically to ensure that no significant drift in the electronics response occurs over time. It is believed that a calibration of one time per year will be sufficient.

1. Measurement System Components

A suitable measurement system is commercially available from SOPRA SA, Bois Colombes, France, and is described in one or more of U.S. Pat. Nos. 5,742,399, 5,818,578, 5,835,230, 5,880,850, 5,949,537, 5,963,336, 5,991,696 and 6,084,668, and co-pending application Ser. No. 09/677,885, Attorney Docket No. 000348-132, filed Oct. 3, 2000, the contents of which documents are incorporated herein by reference.

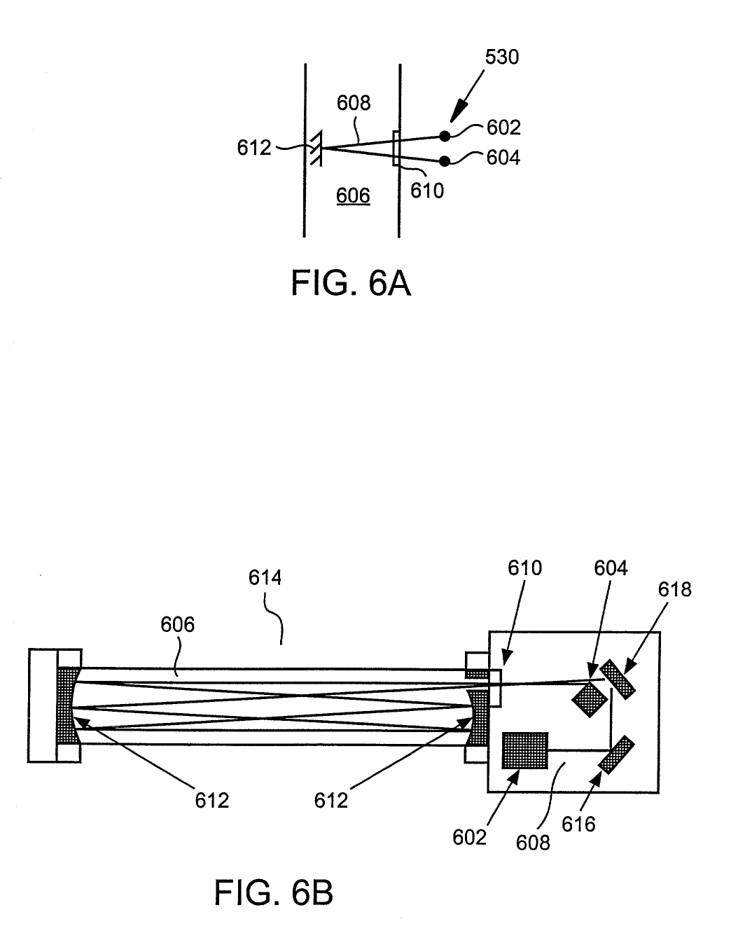

With reference to FIG. 6A, the absorption spectroscopy measurement system 530 comprises a light source 602 and a detector 604, which can be a photodiode, in optical communication with a sample region 606. In this exemplary embodiment, the sample gas is preferably introduced into the sample region during the vacuum phase and/or purge phase of the vacuum/purge cycle by the vacuum device 528 connected downstream of the measurement system.

In order to detect the molecular species of interest, e.g., water vapor, it is important that a light source which emits light of a wavelength characteristic thereof is employed. Laser light sources which emit light in spectral regions where the molecular species absorb most strongly lead to improvements in measurement sensitivity.

Any suitable wavelength-tunable light source can be used. Of the currently available light sources, diode laser light sources are preferred because of their narrow linewidth (less than about 10⁻³cm⁻¹) and relatively high intensity (about 0.1 to several milliwatts) at the emission wavelength. The diode is preferably of the distributed feedback (DFB) type, ensuring single mode emission, i.e., to ensure that the diode emits at a single frequency, as described in M. Feher et al, Spectrochimica Acta A 51 pp. 1579-1599 (1995). In accordance with a preferred aspect of the invention, an InGaAsP/InP Distributed Feedback (DFB) diode laser operating at about 1.368 μm is employed as the light source 602 in order to use the strongest absorption lines for H₂O in the near infrared.

Suitable light sources for use in the invention are not, however, limited to diode lasers. For example, other types of lasers which are similarly sized and tunable by simple electrical means, such as fiber lasers and quantum cascade lasers, can be employed. The use of such lasers as they become commercially available is envisioned.

Light source electronics control the current applied to the diode laser or other light source such that it emits light of a specific wavelength which is absorbed by the molecular species of interest. As current applied to the laser diode increases, wavelength increases or decreases depending on the diode type. Laser current controllers are known in the art and are commercially available, for example, the ILX Lightwave LDX-3620.

Light beam 608 which is generated by the described light source 602 is transmitted into the sample region 606 through at least one light transmissive window 610. The measurement system can be configured such that light beam 608 is reflected by one or more light reflective surfaces 612 within the sample region and exits sample region 606 through the same window 610 it enters the sample region through. Alternatively, the windows through which the light beam enters and exits the sample region can be different and can be disposed on different sides of the sample region 606. The measurement system can also be configured such that the light beam passes straight through the sample region from a light inlet window through a light exit window without being reflected in the sample region.

Light reflective surface 612 can be formed either separate from or integral with a wall defining the sample region. Light reflective surface 612 is preferably a polished metal. As a high reflectivity of this surface is desirable, the surface can be coated with one or more layers of a reflective material such as gold, other metallic layers or a highly reflective dielectric coating in order to enhance the reflectivity thereof. Moreover, to minimize the adverse effects created by deposits formed on the light reflective surfaces, a heater for heating the light reflective surface can also be provided.

FIG. 6B illustrates a multipass measurement cell 614 which includes a plurality of mirrors 612 (or one mirror having multiple faces). This allows the light beam to pass through the sample region a plurality of times. By increasing the effective pathlength in this manner, sensitivity of the measurement system is thereby enhanced. Such a cell can have a path length, for example, of up to 17 meters. Of the various multipass designs, the cell used in the present invention is preferably of the Herriott type, as illustrated.

The absorption spectroscopy measurement system 530 can further include first and second mirrors 616, 618 for reflecting the light beam 608 from the light source 602 through light transmissive window 610 into the sample region. Other mirror schemes for manipulating the light beam are envisioned. Mirrors 616, 618 as shown are flat, but can alternatively be curved if it desired to collimate the light beam.

A detector 604, such as a photodiode, responds to light of the same wavelength as emitted by the diode laser. Detector 604 responds to light beam 608 which exits the sample region through light transmissive window 610. Detector 604 is preferably an InGaAs photodiode. Suitable detectors are commercially available, for example, the EG&G InGaAs C30641 for near infrared detection, with a 10-MHZ bandwidth amplifier.

Detector electronics receive the output from the detector and generate an output which is related to the absorbence of light at the desired wavelength. The absorbence (A) is defined as A=1−T, wherein T is the transmittance, i.e., the ratio of the detected light intensity in the presence of the water vapor measured to the intensity which would be observed in its absence. The absorbance can be converted into a concentration of the molecular impurities by a computer using known calibration data.

Various methods for controlling the wavelength of the light emitted by the diode laser can be used. For example, the laser wavelength may be locked to the desired value by a feedback system. Alternatively, it may be rapidly and repetitively swept by modulating the diode current with a sawtooth function over a region which includes the desired wavelength of the absorption line of the molecular species of interest to generate a spectrum. The region is selected to be free of interference from other species which may be present in the gas line network, for example the purge gas. Subsequent spectra may be averaged to improve sensitivity. Both of these techniques are known. See, e.g., Feher et al., Tunable Diode Laser Monitoring of Atmospheric Trace Gas Constituents, Spectrochimica Acta, A 51, pp. 1579-1599 (1995) and Webster et al., Infrared Laser Absorption: Theory and Applications, Laser Remote Chemical Analysis, R. M. Measuews (Ed.), Wiley, N.Y (1988).

Further improvements in sensitivity can be achieved by modulating the diode current and wavelength and demodulating the detector signal at the modulation frequency or one of its higher harmonics. This technique is known as harmonic detection spectroscopy. See, Feher et al., Tunable Diode Laser Monitoring of Atmospheric Trace Gas Constituents, Spectrochimica Acta, A 51, pp. 1579-1599 (1995) and Webster et al., Infrared Laser Absorption: Theory and Applications in Laser Remote Chemical Analysis, R. M. Measuews (Ed.), Wiley, N.Y (1988).

Suitable signal demodulation and numerical data treatment makes measurements of the moisture partial pressure feasible with a typical sampling rate of 0.5 Hz. In addition, the sensor requires in principle no calibration since it is based on the absorption of incident laser light, which depends solely on the concentration of the molecular species being measured, the optical pathlength, the gas pressure and molecular parameters (e.g., oscillator strength).

In accordance with an exemplary embodiment of the invention, the laser wavelength is modulated, for example, at 10 Hz, using a repetitive current ramp which scans over the wavelength range where water vapor absorbs the incident light. A second modulation at 128 kHz is also applied to the diode and phase-sensitive detection is used to select the component of the detector signal which is in phase with the second harmonic of the modulation signal (256 kHz), as described above.

Software locates the minimum and the maximum signal values during the scan. The difference between these is referred to as the “peak-to-peak” signal or “pp2f”. The absolute value of the light intensity is determined from the DC component of the detector signal corresponding to the absorption peak. Interpolation of the DC signal trace on either side of the peak is used to correct for the change in light intensity due to absorption.

A matrix of pp2f values is precalculated by evaluating Equation (2) above, for a range of pressures and temperatures and the chosen value of the modulation amplitude m. This is loaded into memory when the sensor is initialized. The observed pp2f value is converted into absorbence using the matrix, the light intensity and a constant factor that accounts for the gain of the electronics. The absorbence is then converted to moisture concentration according to Beer's Law using Equation (1) above.

A monitor 538 can be provided for real-time display of the moisture concentration along with some key parameters such as the system pressure, laser power, etc. A D/A converter is used to provide a 0-5V analog output proportional to the moisture signal, as well as alarm signals as required.

3. Control of Vacuum/Purge Cycles

In accordance with the present invention, a signal corresponding to the measured level of the molecular species in the sample region 606 can be used to control the gas panel such that the system of valves, regulators, and other flow control devices can be automatically controlled in a desired manner.

For example, a control signal from the absorption spectroscopy measurement system 530 can be sent to a controller 540 which, in turn, sends a control signal to automatic valves V1-V6 and other flow control devices in the gas delivery system. The controller 540 can control, for example, one or more of the following: duration of each vacuum and purge phase, whether based on time or target pressure; flowrate and pressure of the purge gas during the purge phase; rate of evacuation during the vacuum phase; and total number of vacuum/purge cycles. The controller 540 can take various forms known to persons skilled in the art, but is preferably a programmable logic controller (PLC) or other type of logic controller. A feedback control loop technique can be implemented with the controller 540 and the valve/flow control system. In this way, the valves and other flow control devices can be automatically controlled based on the measured value obtained from the measurement system.

The following is a description of a method for delivery of a gas in accordance with one exemplary aspect of the invention using the above-described apparatus. While the method is described in the context of replacement of a gas cylinder, other applications in addition to those described herein are envisioned.

At the beginning of this process, typically after semiconductor processing, the condition of the valves in the gas delivery system is as follows: cylinder valve 506 is open; valves V1 and V2 are open; and valves V3, V4, V5 and V6 are closed. To shut off flow of the gas from the cylinder 504, cylinder valve 506 is closed. Any residual process gas in the gas line network is next removed from the system by one or more vacuum/purge cycles. The vacuum/purge cycles can be started with either the vacuum phase or the purge phase. Typically, the vacuum phase is first performed.

To initiate the vacuum phase, valves V1 and V4 are in the closed position, and valves V3 and V6 are in the opened position. Gas line 510 up to the gas cylinder, vacuum/purge line 516 and vacuum line 526 are thereby evacuated by the vacuum device 528. The removed gas passes through the measurement system 530 and vacuum device 528, which is typically connected to the facility's exhaust and scrubber system (not shown). During the vacuum phase, the level of the molecular species of interest is monitored, preferably continuously, by the measurement system 530. The molecular species of interest during this phase preferably corresponds to the specific gas in the cylinder being replaced, or to one of the gases in the case of a gas mixture.

The duration of the vacuum phase is typically based on a predetermined period of time, or on the attaining of a predetermined base vacuum level as measured by a suitable vacuum gauge. Once the level of the species falls to a predetermined level, the vacuum/purge cycling can be stopped. Where the molecular gas species of interest is a toxic, corrosive or pyrophoric gas, the target concentration of the measured species is typically less than about 10 ppm, although this is species dependent.

Assuming the vacuum phase ends without reaching the predetermined concentration level for the molecular species, the purge phase of the vacuum/purge cycle is started. Valve V6 is closed or maintained in the open position depending on whether sampling during the purge phase is desired, and valve V5 is opened, allowing nitrogen purge gas to pressurize the gas lines 510 and 516. In the case valve V6 is closed and no sampling through the measurement system is practiced, the duration of the purge phase is typically a predetermined time period, although it may be performed until a predetermined pressure in the gas piping is attained as measured by a suitable pressure gauge. If V6 is maintained in the open position, the purge phase continues as described in the case sampling is not performed unless the level of the measured species reaches the predetermined, target value.

Assuming the target value has not been reached, following the purge phase, the vacuum phase is again performed by closing valve V5 and opening valve V6 if not already in the opened position. The vacuum and purge phases are continued until the level of the measured species reaches the predetermined value.

When the concentration of the molecular species has been reduced to the target level, it is assumed that the process gas no longer is present in the gas lines or is present in a sufficiently small amount that the gas cylinder can safely be disconnected. Prior to disconnecting the gas cylinder from fitting 508, valve V5 is opened. This allows a continuous stream of nitrogen to flow from the fitting 508 to prevent the ingress of air and contamination of the gas line when the fitting is exposed to atmosphere. Fitting 508 is next disconnected from the cylinder 504.

The empty cylinder is removed and is replaced with a fresh cylinder. After connecting the fresh cylinder to the fitting 508, valve V5 is closed, and the vacuum phase of the vacuum/purge cycle is initiated. The cycle is performed as described above to remove ambient contamination such as water vapor from the system prior to opening the cylinder valve 506.

At this stage, the molecular species being monitored by the measurement system 40 is advantageously water vapor. In the case of water vapor, the predetermined concentration level is preferably from about 0.01 ppm to 10 ppm. Once this predetermined level has been reached, it assumed safe to introduce the process gas from the cylinder into the gas distribution system, and to the point of use.

In the event the connection between the gas cylinder and the fitting 508 does not provide a sufficient seal, air will leak into the system during the vacuum phase. As a result, the desired base vacuum level and the desired moisture level during the vacuum phase would likely not be attained. Interlock values, for example, maximum values for the number of vacuum/purge cycles and/or time to reach the setpoint base vacuum level during the vacuum phase, can be programmed into the controller 540. In the case of such abnormal condition(s), the controller 540 can send a signal to an audio and/or visual alarm 542 indicating the problem. If this should happen, the operator would then perform a leak check using known methods, for example, with a soapy water solution or a helium leak detector, to isolate the problem area.

In addition to the gas cylinder cabinet 502, the measurement system can be connected to, for example, one or more additional gas cylinder cabinet 502′, vacuum manifold box (VMB) 544 or process tool gas panel 546, with the understanding that sampling through the measurement system should only be conducted for one of those units at a time.

If the gas source is a liquid at standard temperature and pressure, for example, in the case of organometallics and the like, a vaporizer or bubbler system is used to provide the gas to the process tool. Such systems are described in the literature and are well known to persons skilled in the art. vacuum/purge cycling for the manifold is similar to that described above in the case of a gas cylinder. Likewise, vacuum/purge cycling for bulk storage vessels is similar to that for the gas cylinders

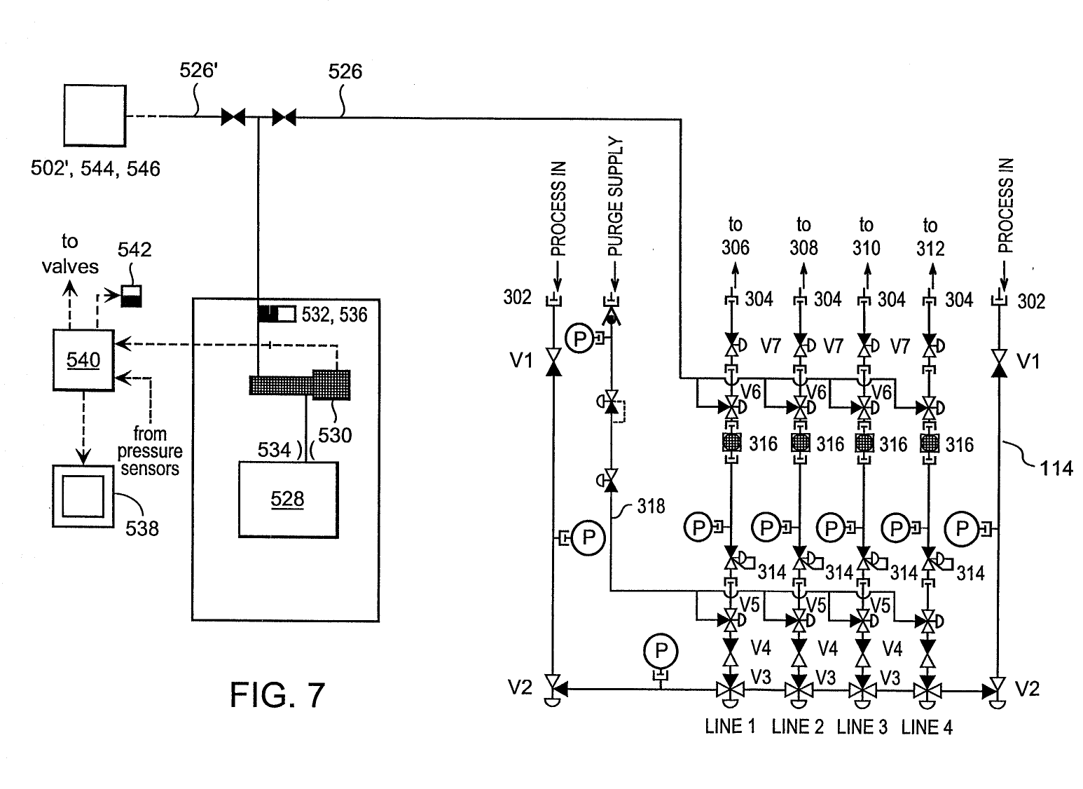

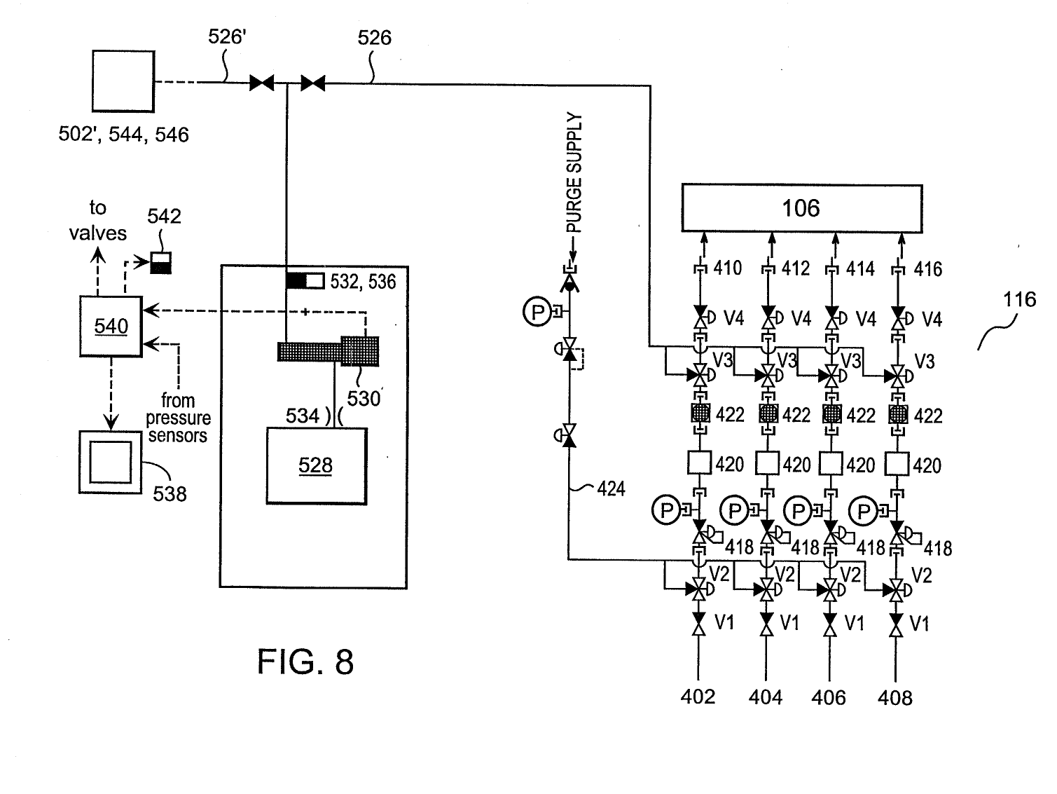

FIG. 7 is a schematic diagram of an exemplary gas delivery apparatus in accordance with the invention, which includes a vacuum manifold box (VMB) 114, and FIG. 8 is a schematic diagram of an exemplary gas delivery apparatus in accordance with the invention, which includes a process tool gas panel 116. When disconnecting components in the VMB or gas panel, for example, valves, regulators, mass flow controllers, filters, etc., for purpose of replacing the components or for performing other maintenance tasks, the gas line network should be vacuum/purge cycled in a similar manner to that described above with reference to the gas purge panel. The valve sequence for a given component of the gas distribution system being replaced or otherwise worked on is well understood by persons skilled in the art. Measurements are conducted during the vacuum phase and/or purge phase with the measurement system 530 also as described above.

While the invention has been described in detail with reference to specific embodiments thereof, it will be apparent to one skilled in the art that various changes and modifications can be made, and equivalents employed, without departing from the scope of the appended claims.

What is claimed is:

1. A gas delivery apparatus, comprising:
a gas line network for delivering a gas from a gas source to a point of use;
means for performing one or more vacuum/purge cycle in the gas line network, the vacuum/purge cycle comprising a vacuum phase and a purge phase; and
a measurement system for detecting a gas phase molecular species in the gas line network during the vacuum phase and/or the purge phase of the vacuum/purge cycle.

2. The gas delivery apparatus according to claim 1, wherein the gas phase molecular species is selected from the group consisting of water vapor, chlorine (Cl₂), boron trichloride (BCl₃), hydrogen chloride (HCl), boron trifluoride (BF₃) and hydrogen bromide (HBr), silane (SiH₄), dichlorosilane (SiH₂Cl₂), trichlorosilane (SiHCl₃), arsine (AsH₃), phosphine (PH₃), diborane (B₂H₆), nitrous oxide (N₂O), ammonia (NH₃), tungsten hexafluoride (WF₆)and organometallic compounds.

3. The gas delivery apparatus according to claim 1, wherein the means for performing one or more vacuum/purge cycle comprises a controller for controlling valves in the gas line network.

4. The gas delivery apparatus according to claim 3, wherein the controller controls the number of vacuum/purge cycles based on output from the measurement system.

5. The gas delivery apparatus according to claim 1, wherein the measurement system is a tunable diode laser absorption spectroscopy (TDLAS), Fourier transform infrared spectroscopy (FTIR), mass spectroscopy (MS), ultraviolet-visible spectroscopy (UV-VIS), or non-dispersive infrared spectroscopy (NDIR) measurement system.

6. The gas delivery apparatus according to claim 1, wherein the measurement system is a tunable diode laser absorption spectroscopy (TDLAS) system.

7. The gas delivery apparatus according to claim 1, wherein the means for performing one or more vacuum/purge cycle comprises a vacuum pump for evacuating the gas line network during the vacuum phase and a purge gas source for pressurizing the gas line network with a purge gas during the purge phase.

8. The gas delivery apparatus according to claim 7, wherein the vacuum pump is connected at a point downstream from the measurement system such that gas evacuated from the gas line network during the vacuum phase passes through the measurement system.

9. The gas delivery apparatus according to claim 1, wherein the point of use is a semiconductor processing tool.

10. The gas delivery apparatus according to claim 1, wherein the gas source is a gas cylinder containing a pressurized gas or a liquified gas.

11. The gas delivery apparatus according to claim 1, wherein the gas source is a bulk storage vessel.

12. The gas delivery apparatus according to claim 1, wherein the gas source is a vaporizer or a bubbler containing a liquid chemical.

13. The gas delivery apparatus according to claim 1, wherein the vacuum/purge cycle performing means is connected to perform the one or more vacuum/purge cycle in a gas purge panel.

14. The gas delivery apparatus according to claim 1, wherein the vacuum/purge cycle performing means is connected to perform the one or more vacuum/purge cycle in a valve manifold box.

15. The gas delivery apparatus according to claim 1, wherein the vacuum/purge cycle performing means is connected to perform the one or more vacuum/purge cycle in a process tool gas panel.

16. A gas delivery apparatus, comprising:
a gas line network for delivering a gas from a gas source to a semiconductor processing tool;
means for performing one or more vacuum/purge cycle in the gas line network, the vacuum/purge cycle comprising a vacuum phase and a purge phase; and
an absorption spectroscopy measurement system for detecting a gas phase molecular species in the gas in a sample region during the vacuum phase and/or the purge phase of the vacuum/purge cycle, the measurement system comprising:
a light source for directing a light beam into the sample region through a first light transmissive window; and a detector which responds to the light beam which exits the sample region through the first light transmissive window or a second light transmissive window.

17. The gas delivery apparatus according to claim 16, wherein the absorption spectroscopy measurement system further comprises one or more light reflective surfaces for reflecting the light beam within the sample region.

18. The gas delivery apparatus according to claim 16, wherein the point of use is a semiconductor processing tool.

19. A method for monitoring a gas phase molecular species in a gas delivery apparatus comprising a gas line network for delivering a gas from a gas source to a point of use, the method comprising:
(a) performing one or more vacuum/purge cycle in the gas line network, the vacuum/purge cycle comprising a vacuum phase and a purge phase; and
(b) detecting with a measurement system a gas phase molecular species in the gas line network during the vacuum phase and/or the purge phase of the vacuum/purge cycle.

20. The method according to claim 19, wherein the one or more vacuum/purge cycle is performed prior to disconnection of a component of the gas line network.

21. The method according to claim 20, wherein the component is a gas cylinder, a bulk storage vessel, a vaporizer or a bubbler.

22. The method according to claim 21, wherein the component is a gas cylinder.

23. The method according to claim 20, wherein the component is a valve, a regulator, a filter or a mass flow controller.

24. The method according to claim 19, wherein the gas phase molecular species is selected from the group consisting of water vapor, chlorine (Cl₂), boron trichloride (BCl₃), hydrogen chloride (HCl), boron trifluoride (BF₃) and hydrogen bromide (HBr), silane (SiH₄), dichlorosilane (SiH₂Cl₂) trichlorosilane (SiHCl₃), arsine (AsH₃) phosphine (PH₃), diborane (B₂H₆), nitrous oxide (N₂O), ammonia (NH₃) tungsten hexafluoride (WF₆)and organometallic compounds.

25. The method according to claim 20, further comprising:
(c) performing one or more vacuum/purge cycle in the gas line network after disconnection and reconnection of the component or connection of a new component, the vacuum/purge cycle comprising a vacuum phase and a purge phase; and
(d) detecting with the measurement system a gas phase molecular species in the gas line network during the vacuum phase and/or the purge phase of step (c).

26. The method according to claim 25, wherein the gas phase molecular species is water vapor.

27. The method according to claim 19, wherein the one or more vacuum/purge cycle is performed after disconnection and reconnection of a component of the gas line network or connection of a new component.

28. The method according to claim 27, wherein the gas phase molecular species is water vapor.

29. The method according to claim 19, further comprising controlling the duration of the vacuum phase and purge phase of the vacuum/purge cycle based on a predetermined time and/or pressure in the gas line network.

30. The method according to claim 29, wherein the duration of the vacuum phase and purge phase is controlled by automatically operating a plurality of valves in the gas line network based on the predetermined time and/or pressure.

31. The method according to claim 19, wherein the number of vacuum/purge cycles is controlled based on output from the measurement system.

32. The method according to claim 19, wherein the measurement system is a tunable diode laser absorption spectroscopy (TDLAS), Fourier transform infrared spectroscopy (FTIR), mass spectroscopy (MS), ultraviolet-visible spectroscopy (UV-VIS), or non-dispersive infrared spectroscopy (NDIR) measurement system.

33. The method according to claim 32, wherein the measurement system is a tunable diode laser absorption spectroscopy (TDLAS) system.

34. The method according to claim 19, wherein gas evacuated from the gas line network during the vacuum phase passes through the measurement system.

35. The method according to claim 19, wherein the point of use is a semiconductor processing tool.

36. A method for monitoring a gas phase molecular species in a gas delivery apparatus comprising a gas line network for delivering a gas from a gas source to a semiconductor processing tool, the method comprising:
(a) performing one or more vacuum/purge cycle in the gas line network prior to disconnection from the gas line network of a component in the gas line network, the vacuum/purge cycle comprising a vacuum phase and a purge phase;
(b) detecting with a measurement system a gas phase molecular species in the gas line network during the vacuum phase and/or purge phase of step (a);
(c) performing one or more vacuum/purge cycle in the gas line network after disconnection and reconnection of the component or connection of a new component, the vacuum/purge cycle comprising a vacuum phase and a purge phase; and
(d) detecting with the measurement system a gas phase molecular species in the gas line network during the vacuum phase and/or purge phase of step (c).

37. The method according to claim 36, wherein the measurement system is a tunable diode laser absorption spectroscopy (TDLAS), Fourier transform infrared spectroscopy (FTIR), mass spectroscopy (MS), ultraviolet-visible spectroscopy (UV-VIS), or non-dispersive infrared spectroscopy (NDIR) measurement system.

38. The method according to claim 36, wherein the measurement system is an absorption spectroscopy measurement system.

39. The method according to claim 36, wherein the component is a gas cylinder, a bulk storage vessel, a vaporizer or a bubbler.

40. The method according to claim 39, wherein the component is a gas cylinder.

41. The method according to claim 36, wherein the component is a valve, a regulator, a filter or a mass flow controller.
